(19) United States
(12) Patent Application Publication
(10) Pub. No.: US 2004/0032054 A1
(43) Pub. Date: Feb. 19, 2004

(54) Compression molded panels

(76) Inventors: David W. Moeller, Eufaula, AL (US); Kenneth A. Roberson, Leawood, KS (US); David M. Hulshof, Leawood, KS (US); Joseph M. Bujold, Weld, ME (US); Chad W. Wood, Kansas City, MO (US)

Correspondence Address: SPENCER, FANE, BRITT & BROWNE, 1000 WALNUT STREET, SUITE 1400, KANSAS CITY, MO, 64106-2140, US

(21) Appl. No.: 10/217,857

(22) Filed: Aug. 13, 2002

(51) Int. Cl. B29C 43/18; B29C 43/20

(52) U.S. Cl. 264/255; 264/259; 264/338

(57) ABSTRACT

A process is provided for producing compressed composite panels for use in door and cabinets and the like, the panels comprising a molded portion comprised of straw or wood fiber and resin and a structural portion comprised of straw fibre and resin and to which may be applied a melamine finish on one surface which also may contain a decorative pattern.

### FIELD OF THE INVENTION

The present invention relates to the field of compression molded panels and cabinet doors and the like. More particularly, the present invention relates to a process of manufacturing molded panels and doors from a mixture of an agricultural fiber and a resin combined with high pressure compression of the mixture into a mold to produce a panel or door. Among the agricultural fibers that are useful in the process and articles of the present invention are wheat straw or soybean straw, virgin wood, waste wood or other agricultural fiber.

### BACKGROUND OF THE INVENTION

The production of doors and cabinet doors having a relief surface has involved either the affixing of molding on to the flat surface of the door or panel being made into a cabinet door or the routing out or carving out of designs and relief on the door or panel. This is a costly, time consuming process requiring craftsmanship and skill and individual attention to each door or cabinet door panel that is constructed.

Some progress in reducing cost and in mass producing doors and cabinet panels has been achieved by the use of computer controlled routers that can accurately and repeatable reproduce relief in doors and cabinet door panels on an automatic basis. However, the cost of such computer controlled router systems is high and the system only can route one style of panel or door relief at a time. Also after the routing process, the cabinet door panels or doors contain defects resulting from poor router blade cutting action in areas where the grain or hardness of the wood changes. These defects must be removed by sanding or filling to prepare the door or panel for accepting a finish.

In recent years a second alternative to mechanical carving or routing of doors and panels has been adopted—the plastic molded door and cabinet door panel. In the use of plastics to form the relief the process of making large quantities of relief-containing doors and panels can be accelerated. However, the molded plastic method is limited in the types of relief that can be produced. Relief having both concave and convex portions of a curve present difficulties in being released from the mold. Therefore, certain type of relief designs cannot be achieved by the use of molded plastic methods.

Another undesirable limitation of the wooden carved or routed door or cabinet door panel is the cost of the solid wood stock used for the doors. While wood panels comprised of laminating together several narrower boards are used today and not full 12, 15 or 24 inch wide solid board, the cost of using such solid wood stock is high. Unless the door design contains stiles and crosspieces that allow the use of smaller boards the high cost of solid boards cannot be avoided.

Thus it would be a useful and valuable addition to the construction options available for doors and cabinet door panels if a method of manufacturing such objects were available which avoided the higher cost of solid wood panels and molded plastic methods while providing a similar look and feel of a door or panel made from wood composites. It also would be use useful and valuable if such a method allowed the production of several relief-containing doors or cabinet door panels at a time rather than being limited to the one-at-a-time production method of routing.

Therefore, it is an object of the present invention to provide compression molding of a decorative panel that does not contain plastic to assist in the molding process.

Another object of the present invention to provide compression molding having a depth of relief or detail that is not achieved or inexpensively achieved through embossing of a composite panel.

Yet another object of the present invention to provide means of affixing a decorative surface to a composite panel as an integral part of the production process while avoiding a separate application step after the production of the composite panel.

Another object of the present invention to provide compression molded product having decorative details which produce those decorative details that can be machined into a composite board product as well as those decorative details that cannot be machined into a composite board product.

Another object of the present invention to provide compression molded product having decorative details and which avoids the surface defects produced during the machining of decorative details into a composite board product.

### SUMMARY OF THE INVENTION

The present invention provides a process by which the multiple steps used in forming a decorative panel from a composite board are combined into a single process. In the process a panel is constructed by a pressing or compressing operation to provide a composite board panel or particle board panel or medium density fiberboard (MDF) panel or the like having a molded or relief containing surface and having a veneer or melamine lamination portion. The process thereby avoids separate steps of lamination of material onto a composite board and cutting and machining of the composite board or laminated composite board to achieve a panel having a laminated component and a molded or relief containing surface.

In one embodiment of the invention a moldable first mixture of agricultural fiber and resin is placed in the mold to fill the relief-containing portion of the mold and a second mixture of agricultural fiber and resin is placed in the mold on top of the first mixture and a backing or backer paper or a thin layer of the first mixture is then added to cover the mold. The mold is then subjected to pressure to form the fiber and resin mixtures into a solid panel having the mold relief thereon and the backer paper adhered thereto.

In another embodiment of the invention a moldable first mixture of agricultural fiber and resin is placed in the mold to fill the relief-containing portion of the mold and a previously produced composite panel such as particle board or MDF or the like is placed in the mold on top of the first mixture and a backing or backer paper is then placed to cover the mold. The mold is then subjected to pressure to form the fiber and resin mixtures into a solid panel having the mold relief thereon and the backer paper adhered thereto.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a flowchart showing the process steps of the present invention.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In general, the inventive process uses an agricultural fiber such as wheat straw or soybean straw or wood fiber which is mixed with a resin to form a mixture which can be compressed into a molded panel having a face containing relief and the panel being capable of taking a painted finish or applied foil finish or the like.

The fiber used in the process is an agricultural fiber such as wheat straw or soybean straw, virgin wood or waste wood or other agricultural fiber. Prior to being added to the resin, the selected fiber is ground to a desired size and dried to a selected moisture content for the process. Specifically, bales of agricultural fiber or straw are first chopped into one to two inch (1″ to 2″) long strands by use of a hog or shredder. The moisture content of the one to two inch straw strands is then adjusted to 4-6% moisture by weight using blowers to direct heated, dry air into the straw driers. After the straw is dried to the proper moisture content it is ground to a final use size which allows passage of the straw through a 30 mesh screen and provides a particle size of approximately 0.023 inches or 0.6 mm. The processing of the straw for mesh sizing is accomplished by use of a hammer mill having ⅛″ or smaller screens to produce a nominal 30 mesh sized straw particle having a moisture content of about 4-6% moisture by weight. The ground straw particles are then held in a silo until needed for process production.

After the agricultural fiber has been prepared to the proper particle size and moisture content it is then mixed with one of several different resins depending upon the type of molding application for which it is intended. The uses being either: (1) the molding of the relief portions of the panel; or (2) the molding of the body portions of the panel. The fiber and resin mixture used in molding the relief portions of the panel is known as facing compound or surface compound. The fiber and resin mixture used in forming the body of the panel is known as substrate compound.

The facing compound or surface compound used in molding the relief areas of the panel is a mixture comprised of approximately fifty percent (50%) of the previously described ground agriculture fiber and approximately fifty percent (50%) melamineformaldehyde resin. Alternative resins such as urea-formaldehyde can be used as well as a mixture of melamine-formaldehyde and urea-formaldehyde resins to form the facing compound mixture. In the actual molding process between 0.15 and 0.45 lbs./ sq. ft. of facing compound is needed to fill the relief areas of a typical mold.

The substrate compound used to form the panel body area is comprised of approximately eighty to ninety percent (80-95%) ground agricultural fiber and ten to twenty percent (5-20%) diphenylmethane diisocyanate resin (MDI) manufactured by BASF. The amount of substrate compound place into the mold varies between 1.8 and 2.8 lbs./ sq. ft. depending on the desired thickness and density of the finished product. The thermo-setting resin binder diphenylmethane diisocyanate resin (MDI) is used to hold together the pulverized straw particles in the molding process. To bind wheat and soybean straw MDI resin is preferred. Resins suitable for binding wood particles for molding include diphenylmethane diisocyanate resin (MDI), urea-formaldehyde, and melamine-formaldehyde (melamine is 2, 4, 6-triamino-1, 3, 5-triazine).

After the mold has been filled with the facing compound and the substrate compound, the filling of which will be described hereinafter, the mold may be left as is or covered with a backer material. If a backer sheet or backer material is used, the contents may be consolidated by a pre-pressing step to partially compress the facing compound and the substrate compound into the mold. The pre-pressing creates a smooth and compacted mat of material in the mold to which the backer materials may be more easily applied and without incurring contamination of the backer materials due to loose material in the mold or tray.

Backer materials may be a decorative material such as a wood veneer, melamine impregnated papers, or paper laminates. The backer material also may be designed to produce a smoother substrate surface when it is desired to finishing the panel or door with paint or powder coating. In such a case a smooth release paper or use of an additional layer of facing compound on the back of the substrate compound may be used. Also, textures may be imparted to the back surface through the use of textured release papers and a smooth cover plate, or by using a textured cover plate during the compression-pressing phase of the process.

To minimize contamination of the melamine impregnated paper or paper or wood veneer backer paper as it is laminated onto the panel during the backer adhesion process the backer paper or sheet and the cover sheet are cleaned prior to their application to the panel. If the cover sheet and the backer sheet are not cleaned loose materials and plant dust and particulates can adhere to the cover sheet or the backer sheet and become pressed into the decorative surface of the final panel.

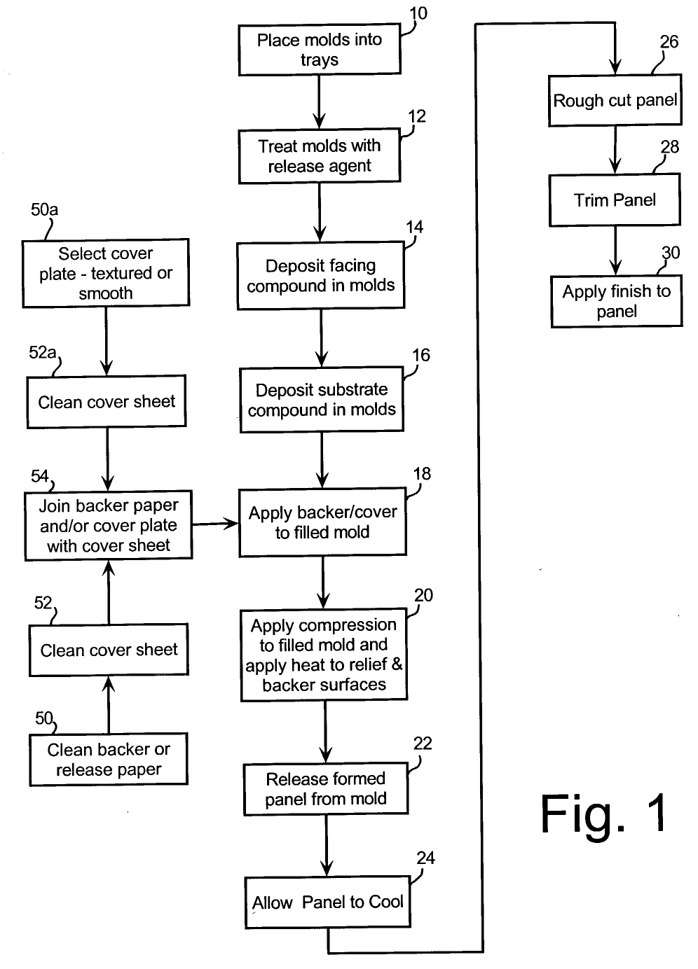

The application process involves preparing the cover sheet by cleaning it with a stream of compressed air (FIG. 1, Step 52) that has been de-ionized by use of a deionizing air nozzle such as that produced by Exair Corporation of 1250 Century Circle North, Cincinnati, Ohio 45246. The backer sheet also is cleaned using a stream of compressed air (FIG. 1, Step 50) that has been de-ionized. The cover sheet is then placed over the backer sheet and the leading edges of the two sheets are aligned and held together (FIG. 1, Step 54). The backer sheet adheres to the cover sheet due to the generation of a static charge by which the cover sheet and the backer sheet are attracted together. The static charges is generated on the cover sheet by use of a static generator connected to an ionizing bar. The static charge is applied to the backer sheet by pulling the backer sheet across the ionizing bar which has previously been charged by the static generator. The static generator and ionizing bar were purchased from SIMCO Industrial Static Control, 2257 North Penn Road, Haffield, Pa. 19440. The combined backer sheet and cover sheet unit is then placed over the tray containing the molds (FIG. 1, Step 18) that have previously been filled with the facing compound and the straw/resin mixture. The covered tray is then introduced into the press to produce the panel. After pressing the cover sheet is removed from the panel.

As the various component portions of the process and materials used in the process now have been described, the actual molding process will be described in detail with reference to FIG. 1. In Step 10, four foot by eight foot trays are filled with product molds. The molds are constructed of aluminum and have machined into them the relief designs that are to be reproduced in the compression molded panels. Once the molds are in place in the trays, the molds are treated, in Step 12, with a release agent to assist with the removal of the molded panel from the mold at the end of the compression step of the process. The tray and molds combination in Step 14 is filled with the facing compound or surface compound which is used to form the relief portion of the final panel. As previously stated, the amount of facing compound needed is approximately 0.15 to 0.45 lbs./sq. ft of mold area. This amount will vary depending upon the depth and amount of relief that is presented in the decorative or relief portion of the mold. The more extensive or deep the relief, the more facing compound required to fill the relief portions of the decorative face of the mold.

After the facing compound of Step 14 is placed within the molds, the molds are then filled in Step 16 with the substrate compound. As previous described, the substrate compound is a mixture of agricultural fiber and MDI resin. Approximately 1.8-2.8 lbs./sq. ft. of the substrate compound is added to the mold depending on the desired thickness and density of the finished panel. Once the molds are filled with the facing compound and the substrate compound the molds are covered with a backer material and a cover plate. Backer paper provides a finish or texture to the back of the finished panel.

Alternatively, if a panel is to receive a paint finish or a powder coat finish no backer sheet or textured release paper is applied to the mold. Instead, a final thin layer of facing compound is applied on top of the substrate compound to provide the back side of the panel with a smooth surface that is suitable for receiving a painted or powdercoat finish. This is then covered with a cover plate (Step 50a) and cover sheet (Step 52a).

After the tray/mold combination is filled with the facing compound and the substrate compound and the backer paper and cover sheet applied, compression of the fiber and resin mixture takes place in Step 20. In the pressing step, between 3000-10,000 psi of hydraulic pressure is applied to the fiber and resin mixture. This hydraulic pressure generates approximately 200 to 800 psi of pressure on the material in the mold. These pressures are calculated pressures that are determined using data provided by the press manufacturer. During the pressing step the mold face containing the relief and the backer surface are heated to a temperature of between 115° C. and 155° C. The pressing or compression of the mixture in the mold is sustained for approximately four (4) to fifteen (15) minutes depending upon the density and thickness of the product produced.

At the end of compression, Step 20, the formed panel is released from the tray and mold combination, Step 22. Upon release of the panel from the mold the panel is allowed to cool, Step 24, prior cutting of the newly formed four foot (4′) by eight foot (8′) panel into individual panels. The single panel released from the mold is first rough cut, Step 26, into individual doors . The rough cut doors are then trimmed, Step 28, to final dimensions and are then ready for application of a final finish, Step 30, such as paint, powdercoat or decorative vinyl laminate, or the like. As an alternative to cutting the large panel apart, it also is possible to include metal dividers between the molds or to place gaps between the adjacent molds to create low density areas between the molds. These alternatives will create low density lines between the adjacent molds which allow the panel to be broken along the lines of weakness and into individual doors.

In an alternative embodiment of the process, a panel having a molded relief surface can be constructed using a previously manufactured composite panel such as particle board or medium density fiberboard (MDF). In this embodiment of the inventive process the composite panel is inserted into the mold in place of the substrate compound. During compression step 20 the facing compound becomes laminated to the composite panel. If a backer paper laminate is desired then it can be either applied to the composite panel during the pressing process or a previously laminated composite panel can be used.

Specifically, after the molds are filled with the facing compound or surface compound which is used to form the relief portion of the final panel, the molds are not filled with the substrate compound. Instead, a precut panel of a composition board such as particle board or medium density fiberboard (MDF) is inserted into the mold on top of the facing compound. The precut composition board may or may not have a backer paper applied to it as has been previously described. The mold is then subjected to the previously described compression and demolding process.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive molded panels are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. A process for the manufacture of relief-containing panels or cabinet doors comprising:
mixing together an agricultural fiber and a resin to produce a fiber-resin mixture,
placing a facing compound into a mold, said mold having at least one surface containing relief patterns, said facing compound comprising between approximately 20% and 50% by weight of melamine-formaldehyde resin and between approximately 50% and 80% by weight of an agricultural fiber,
introducing said mixture into a mold, said mold having at least one surface containing relief patterns,
heating said at least one surface of said mold containing relief patterns, and
compressing said mixture into said mold at a pressure of less than 1000 psi.

2. The process as claimed in claim 1 wherein said agricultural fiber is straw.

3. The process as claimed in claim 1 wherein said agricultural fiber is soybean straw.

4. The process as claimed in claim 1 wherein said agricultural fiber is wood.

5. The process as claimed in claim 1 wherein said mixture comprises an amount of agricultural fiber of between approximately 80% and 95% by weight and an amount of resin of between approximately 5% and 20% by weight.

6. The process as claimed in claim 1 further comprising the step of treating said molds with a release agent.

7. The process as claimed in claim 1 further comprising the step of placing a backer paper onto said mixture.

8. The process as claimed in claim 1 wherein said mold comprises sidewalls having a height that is approximately the height of the final molded panel.

9. The process as claimed in claim 1 further comprising the step of placing a cover plate onto said mixture.

10. The process as claimed in claim 9 wherein said cover plate comprises a textured surface.

11. A process for the manufacture of relief-containing panels or cabinet doors comprising:
placing a facing compound into a mold, said mold having at least one surface containing relief patterns, said facing compound comprising between approximately 50% and 80% by weight of melamine-formaldehyde resin and between approximately 50% and 80% by weight of an agricultural fiber,
introducing a composite panel into the mold,
heating said at least one surface of said mold containing relief patterns, and
compressing said mixture into said mold at a pressure of less than 1000 psi.

12. The process as claimed in claim 11 wherein said agricultural fiber is straw.

13. The process as claimed in claim 11 wherein said agricultural fiber is soybean straw.

14. The process as claimed in claim 11 wherein said agricultural fiber is wood.

15. The process as claimed in claim 11 wherein said mixture comprises an amount of agricultural fiber of between approximately 80% and 95% by weight and an amount of resin of between approximately 5% and 20% by weight.

16. The process as claimed in claim 11 further comprising the step of treating said molds with a release agent.

17. The process as claimed in claim 11 further comprising the step of placing a backer paper onto said mixture.

18. The process as claimed in claim 11 wherein said mold comprises sidewalls having a height that is approximately the height of the final molded panel.

19. The process as claimed in claim 11 further comprising the step of placing a cover plate onto said mixture.

20. The process as claimed in claim 19 wherein said cover plate comprises a textured surface.
